(19) United States
(12) Patent Application Publication
(10) Pub. No.: US 2003/0198040 A1
(43) Pub. Date: Oct. 23, 2003

(54) Luminescent book

(76) Inventors: Jen-Fu Chen, Feng Yuan City (TW); Chih-Shen Chen, Taichung (TW); Shing-Chih Kao, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/125,263

(22) Filed: Apr. 18, 2002

(51) Int. Cl. F21V 9/16

(52) U.S. Cl. 362/84; 362/98

(57) ABSTRACT

A luminescent book includes a frame. A luminescent panel, a film switch, a circuit board and a back plate are sequentially mounted on the frame. The circuit board is electrically connected with the luminescent panel and the film switch for providing information in several modes. The luminescent panel includes a plurality of areas each of which is formed with a pattern and can be activated regardless of the other. A speaker is electrically connected with the circuit board. In a first mode, the patterns are highlighted sequentially. When a pattern is highlighted, sound is provided. The process repeats once if the first button is pressed within a period of time after the last pattern is highlighted and ends if otherwise. In a second mode, one of the patterns can be pressed so that it is highlighted before sound representative of the pressed pattern is provided. The process repeats if any of the patterns is pressed within a period of time after the sound is provided and ends if otherwise. In a third mode, one of the patterns is randomly highlighted. The process ends if the highlighted pattern is not pressed within a period of time after the highlighting starts and sound is provided if otherwise. In a fourth mode, a song is played. The process repeats if the fourth button is pressed within a period of time after the song is over and ends an end if otherwise.

### BACKGROUND OF INVENTION

1. Field of Invention

The present invention is related to a luminescent book.

2. Related Prior Art

People have been reading conventional books for information and entertainment for a very long time. Now, there are electronic books capable of providing more information and visual effects than the conventional books. Some electronic books can even provide sound effects. However, such so-called electronic books are in fact media for storing information such as CD ROM, disks and cards. Therefore, the information stored in a so-called electronic book must be played by means of a computer of some kind. Such a computer may be a desktop computer, a notebook computer or a palm computer. These computers are however expensive and weak and therefore are not suitable for people to carry. Kids are particularly not supposed to carry these computers, yet they need the visual effects and the sound effects more than adults do. Some of the computers such as desktop computers are in fact too heavy to carry.

The present invention is therefore intended to satisfy people's needs that have not been satisfied in prior art.

### SUMMARY OF INVENTION

It is an objective of the present invention to provide a luminescent book.

It is another objective of the present invention to provide an interactive luminescent book.

It is another objective of the present invention to provide an in-expensive luminescent book.

It is another objective of the present invention to provide a light luminescent book.

It is another objective of the present invention to provide a luminescent book that can be carried easily.

In the present invention, a luminescent book includes a frame, a luminescent panel mounted on the frame, a film switch mounted on the frame next to the luminescent panel, a circuit board mounted on the frame and electrically connected with the luminescent panel and the film switch for providing information in a plurality of interactive modes and a back plate mounted on the frame for retaining the luminescent panel, the film switch and the circuit board on the frame.

The luminescent panel is divided into a plurality of areas each of which is formed with a pattern and can be activated regardless of the other.

A speaker is electrically connected with the circuit board.

The frame includes first, second, third and fourth buttons provided thereon and electrically connected with the circuit board. Each of the buttons can be pressed to select a corresponding interactive mode of provision of information.

The first button can be pressed to start a first mode in which the circuit board drives the luminescent panel to highlight the patterns sequentially and when a pattern is highlighted, the circuit board drives the speaker to provide sound representative of the highlighted pattern, and the process repeats once if the first button is pressed within a period of time after the last pattern is highlighted and ends if otherwise.

The second button can be pressed to start a second mode in which one of the patterns can be pressed so that the film switch detects the motion and sends a signal representative of the pressed pattern to the circuit board so that the circuit board drives the luminescent panel to highlight the pressed pattern before circuit board drives the speaker to provide sound representative of the pressed pattern. The process repeats if any of the patterns is pressed within a period of time after the sound is provided and ends if otherwise.

The third button can be pressed to start a third mode in which the circuit board drives the luminescent panel to randomly highlight one of the patterns, and the process ends if the highlighted pattern is not pressed within a period of time after the highlighting starts and the circuit board drives the speaker to make sound representative of the highlighted pattern if otherwise.

The fourth button can be pressed to start a fourth mode in which the circuit board drives the speaker to play a song representative of the patterns. The process repeats if the fourth button is pressed within a period of time after the song is over and ends if otherwise.

The luminescent book may include a screen located between the frame and the luminescent panel. The screen may be printed with any preferred color. The screen is transparent to allow the information provided by the luminescent panel to be visible through the screen.

The frame includes two hooks projecting from a rear side thereof. The back plate defines two holes for receiving the hooks, thus securing the back plate to the frame.

In another aspect, the luminescent panel is formed with a pattern and a plurality of words among which only one is correct in representing the pattern. The pattern is highlighted and sound is provided if the right word is pressed, and the pattern remains dim and the speaker remains silent if otherwise.

The luminescent book may include a sound detector connected with the circuit board.

The luminescent book may include an optical detector connected with the circuit board.

The luminescent book may include a thermometer connected with the circuit board.

The luminescent book may include a hygrometer connected with the circuit board.

The luminescent book may include a pressure gauge connected with the circuit board.

The luminescent book may include a wireless transceiver connected with the circuit board.

The luminescent book may include a wireless identifier connected with the circuit board.

The luminescent book may include a page switch connected with the circuit board.

Other objects, advantages, and novel features of the invention will become more apparent from the following detailed description when taken in conjunction with the accompanying drawings.

### BRIEF DESCRIPTION OF DRAWINGS

The present invention is described through detailed illustration of embodiments referring to the attached drawings wherein:

FIG. 1 is a perspective view of a luminescent book according to the present invention;

FIG. 2 is an exploded view of the luminescent shown in FIG. 1;

FIG. 3 is a block diagram of a circuit implemented in the luminescent book shown in FIG. 1;

FIG. 4 is a block diagram of a circuit for selection of one from several available modes for provision of information;

FIG. 5 is a flow chart of a first mode for provision of information;

FIG. 6 is a flow chart of a second mode for provision of information;

FIG. 7 is a flow chart of a third mode for provision of information;

FIG. 8 is a flow chart of a fourth mode for provision of information;

FIG. 9 is a perspective of the luminescent book shown in FIG. 1 in the second mode for provision of information shown in FIG. 6;

FIG. 10 is a perspective view of a luminescent book according to a second embodiment of the present invention;

FIG. 11 is similar to FIG. 10, but showing the luminescent book in another status;

FIG. 12 is an exploded vie w of the luminescent book shown in FIG. 1e quipped with a sound detector;

FIG. 13 is a block diagram of a circuit implemented in the luminescent book shown in FIG. 12;

FIG. 14 is a block diagram similar to FIG. 13, but showing an optical detector in place of the sound detector;

FIG. 15 is a block diagram similar to FIG. 13, but showing a thermometer in place of the sound detector;

FIG. 16 is a block diagram similar to FIG. 13, but showing a hygrometer in place of the sound detector;

FIG. 17 is a block diagram similar to FIG. 13, but showing a pressure gauge in place of the sound detector;

FIG. 18 is a block diagram similar to FIG. 13, but showing a wireless transceiver in place of the sound detector;

FIG. 19 is a block diagram similar to FIG. 13, but showing a wireless identifier in place of the sound detector; and

FIG. 20 is a block diagram similar to FIG. 13, but showing a page switch in place of the sound detector.

### DETAILED DESCRIPTION OF PREFERRED EMBODIMENTS

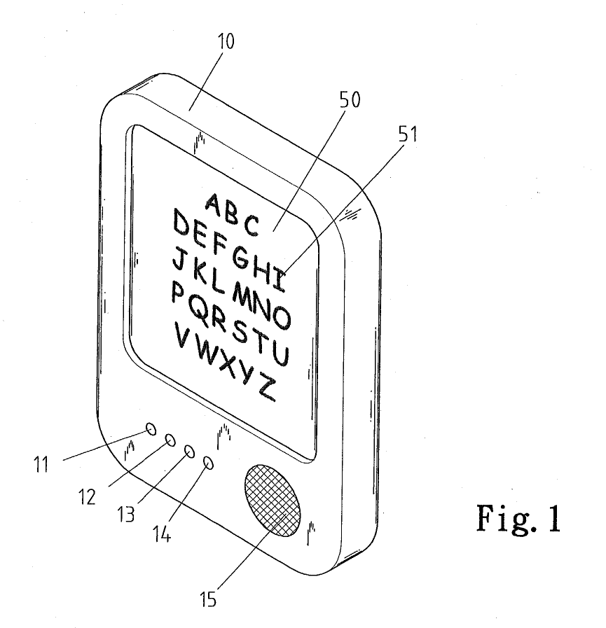

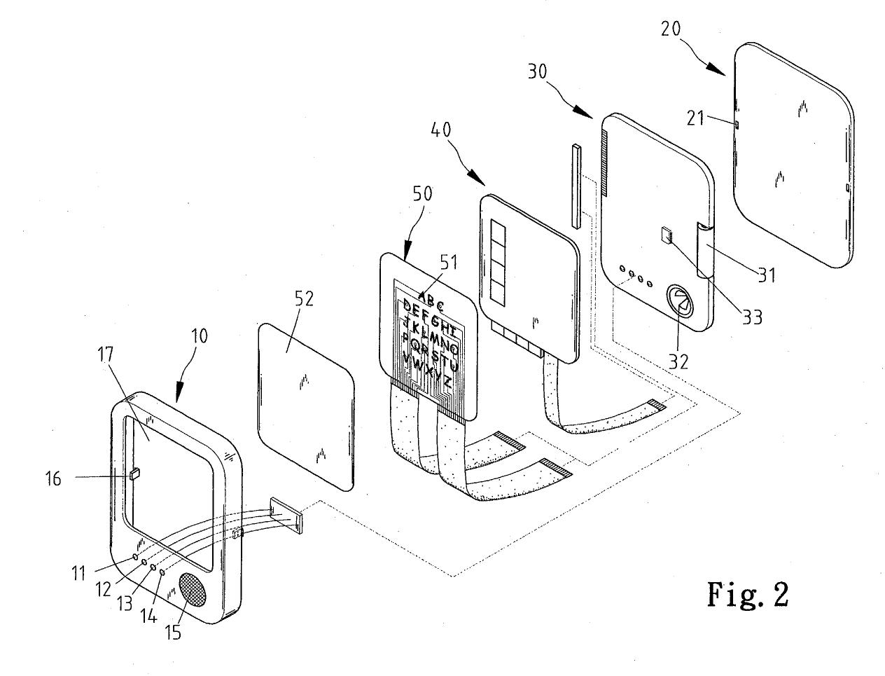

Referring to FIGS. 1 and 2, a luminescent book according to the present invention includes a frame 10, a screen 52, a luminescent panel 50, a film switch 40, a circuit board 30 and a back plate 20.

The frame 10 includes a first button 11, a second button 12, a third button 13 and a fourth button 14 provided thereon. Each of the buttons 11 to 14 can be pressed to select a corresponding interactive mode of provision of information. A net 15 is mounted on the frame 10 covering a hole defined in the frame 10. The frame 10 includes two hooks 16 projecting from a rear side thereof for engagement with the back plate 20 to be described. A window 17 is defined in the frame 10 through which information provided on the luminescent panel 51 is visible.

The screen 52 is mounted on the rear side of the frame 10 so that the window 17 is covered by means of the screen 52. The screen 52 may be printed with any preferred color. To allow the information provided by the luminescent panel 52 to be visible through the screen 52, the screen 52 is transparent. The screen 52 is flexible for reasons to be described.

The luminescent panel 50 is mounted on the frame 10 next to the screen 52. The luminescent 18 panel 50 is printed with a pattern 51. Although not shown, the luminescent panel 50 is in fact 19 divided into a plurality of areas. Each of the areas of the luminescent panel 50 is formed with a pair of electrodes so that it can be driven with electricity regardless of other areas of the luminescent panel 50. Accordingly, the pattern 51 is in fact divided into a plurality of elements corresponding to the areas of the luminescent panel 50. In this embodiment, the pattern 51 consists of 26 elements, i.e., alphabets “A” to “Z.” Each of the alphabets can be highlighted regardless of other alphabets.

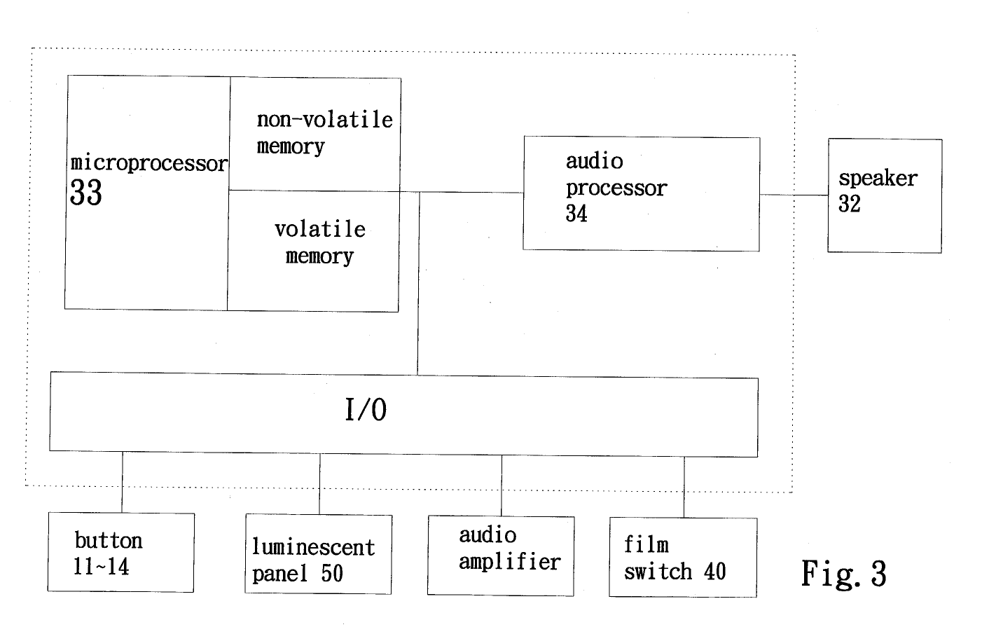

The film switch 40 is mounted on the frame 10 next to the luminescent panel 50, and is electrically connected with an audio integrated circuit (“IC”) 34 (see FIG. 3) installed on the circuit board 30.

The circuit board 30 is mounted on the frame 10 next to the film switch 40. A battery 31 is mounted on the circuit board 30 for providing electricity to the circuit board 30, elements mounted on the circuit board 30, the film switch 40 and the luminescent panel 50. A speaker 32 is installed on the circuit board 30 for providing sound. A microprocessor 33 is installed on the circuit board 30.

The back plate 20 is mounted on the frame next to the circuit board 30. Two holes or slots 21 are defined in the back plate 20. The hooks 16 formed on the frame 10 can be inserted in the holes 21 defined in the back plate 20, thus retaining the circuit board 30, the film switch 40, the luminescent panel 50 and the screen 52 between the frame 10 and the back plate 20.

FIG. 3 is a block diagram of a circuit implemented in the luminescent book shown in FIGS. 1 and 2.

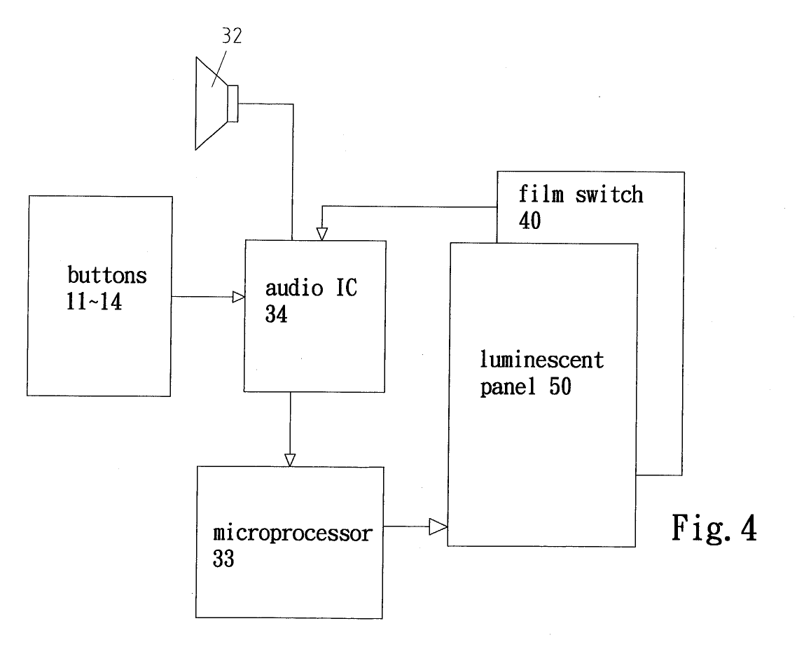

Referring to FIG. 4, the buttons 11 to 14 are electrically connected with the audio IC 34 that is further electrically connected with the speaker 32. The audio IC 34 is electrically connected with the microprocessor 33. The microprocessor 33 is electrically connected with the luminescent panel 50. Four interactive modes for providing information are available and will be described referring to FIGS. 4 to 7.

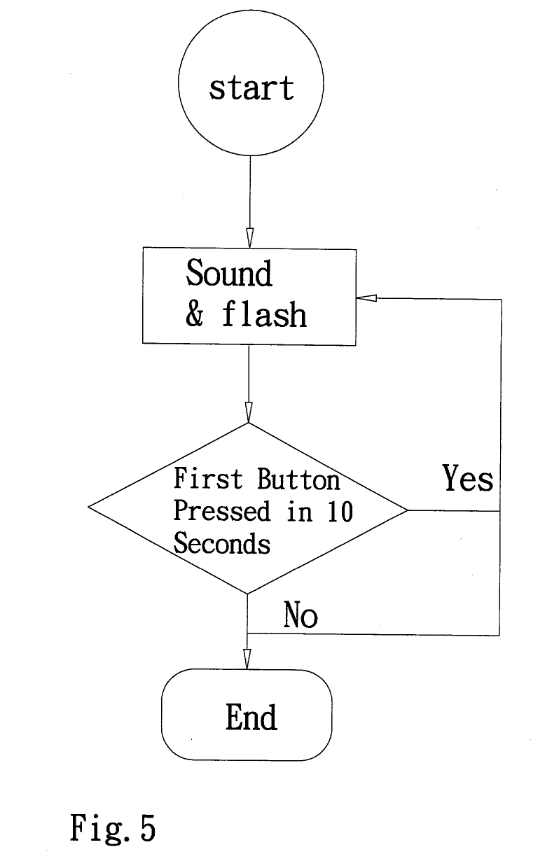

When the first button 11 is pressed, the first mode for providing information as shown in FIG. 5 is initiated. The microprocessor 33 drives the luminescent panel 50 to emit light so as to highlight the alphabets sequentially. It may be programmed that each alphabet be highlighted twice before the next alphabet is highlighted. When an alphabet is highlighted, the audio IC 34 drives the speaker 32 to provide sound representative of the alphabet. The process repeats once if the first button 11 is pressed within 10 seconds after the last alphabet is highlighted. The process ends if the first button 11 is not pressed within 10.

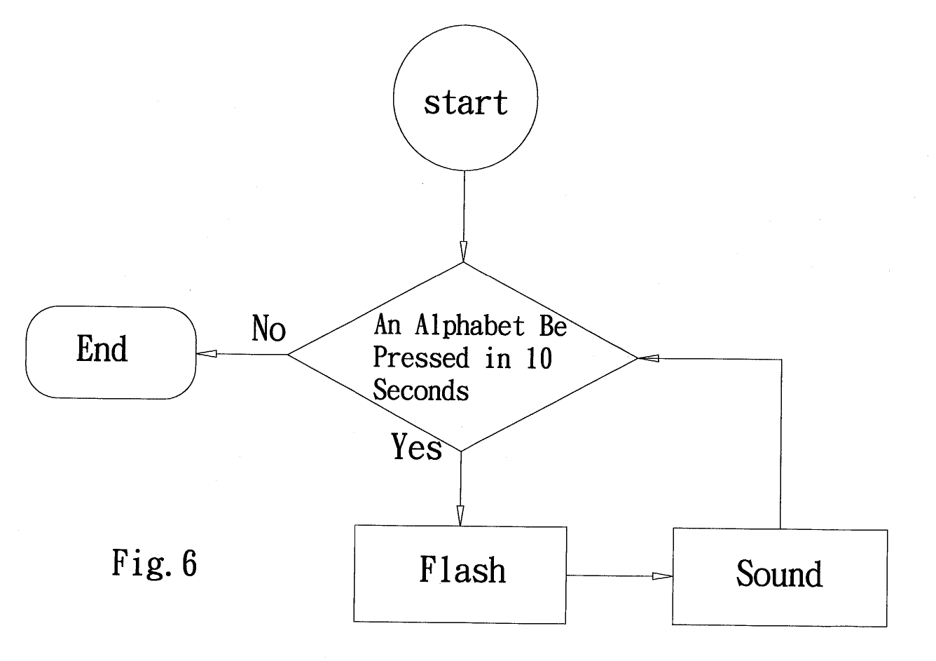

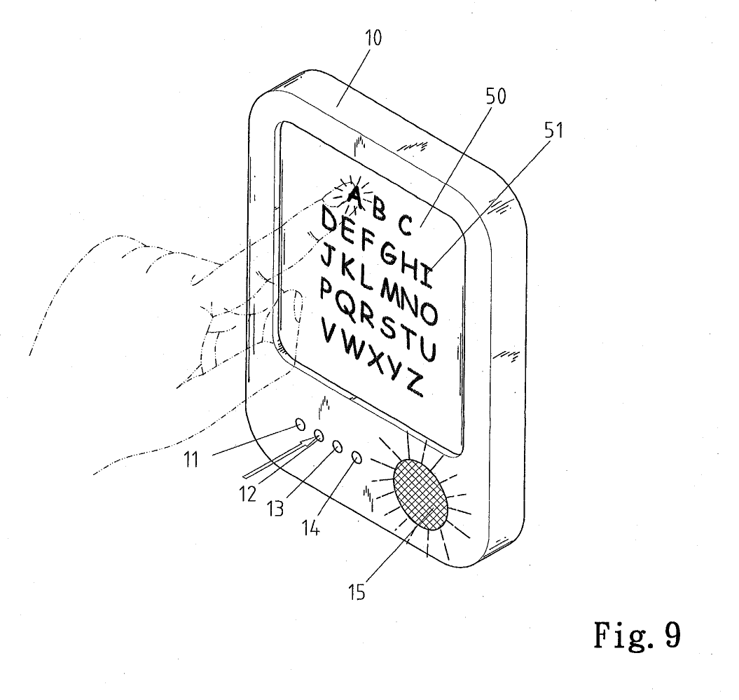

When the second button 12 is pressed, the second mode for providing information as shown in FIG. 6 is initiated. A user can press one of the alphabets printed on the luminescent panel 50 with his finger as shown in FIG. 9. The film switch 40 detects the user's motion and sends a signal representative of the pressed alphabet to the microprocessor 33. On receiving the signal, the microprocessor 33 accordingly drives the luminescent panel 50 to emit light so as to highlight the pressed alphabet twice before the audio IC 34 drives the speaker 32 to provide sound representative of the pressed alphabet. The process repeats if any of the alphabets is pressed within 10 seconds after the sound is provided. The process ends if none of the alphabets is pressed within 10 seconds after the sound is provided.

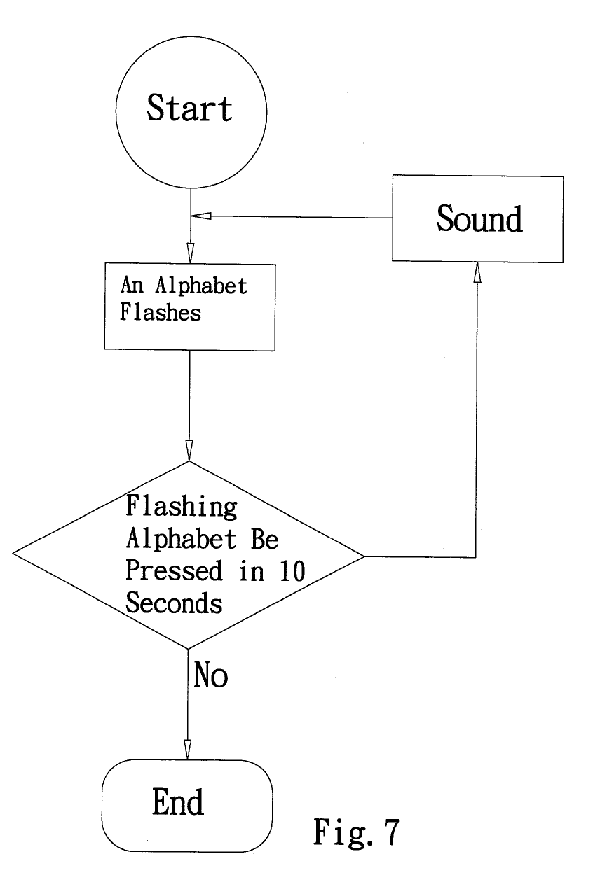

When the third button 13 is pressed, the third mode for providing information as shown in FIG. 7 is initiated. The microprocessor 33 drives the luminescent panel 50 to emit light so as to randomly highlight one of the alphabets twice. The process ends if the highlighted alphabet is not pressed within 30 seconds after the highlighting starts. If the highlighted alphabet is pressed within 30 seconds after the highlighting starts, the audio IC 34 drives the speaker 32 to make sound representative of the highlighted alphabet, and the process repeats once.

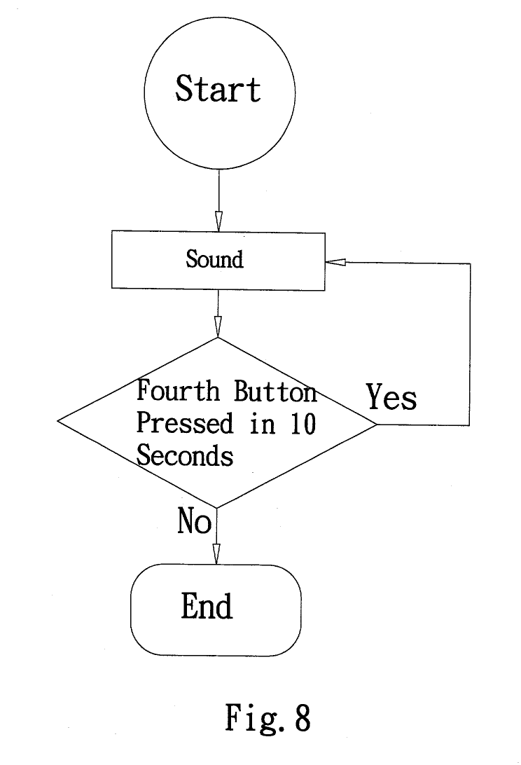

When the fourth button 14 is pressed, the fourth mode for providing information as shown in FIG. 8 is initiated. The audio IC 34 drives the speaker 32 to play the alphabetic song. The process repeats once if the fourth button 14 is pressed within 10 seconds after the song is over. The process ends if the fourth button 14 is not pressed within 10 seconds after the song is over.

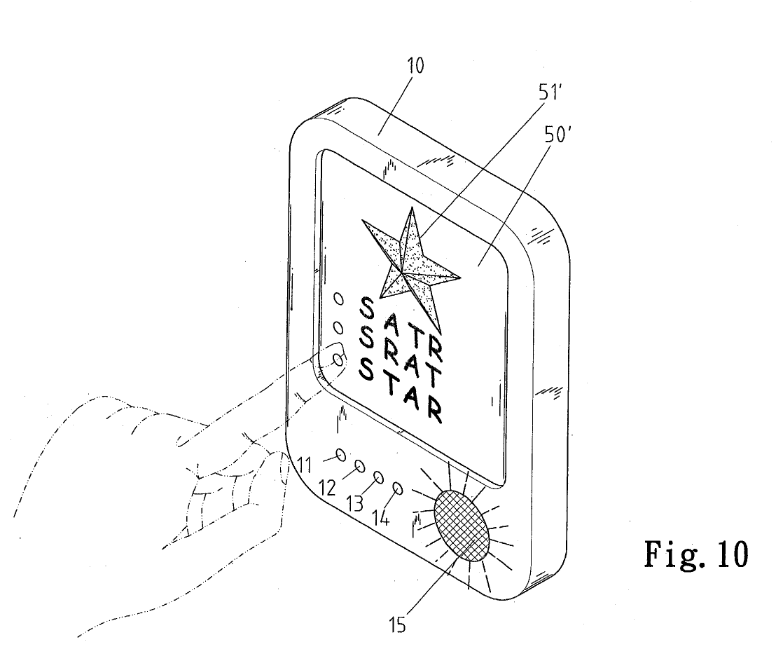

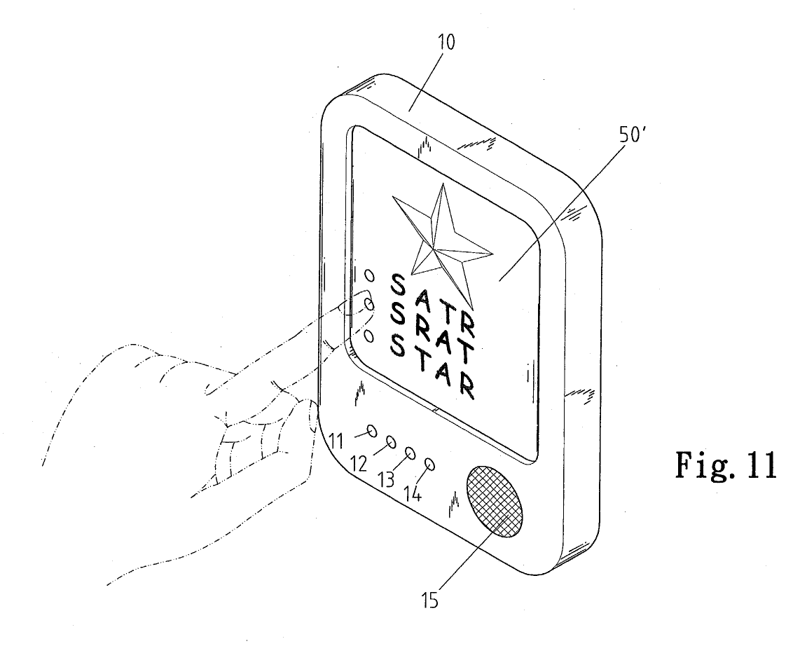

Referring to FIGS. 10 and 11, a luminescent panel 50′ is used in a second embodiment in place of the luminescent panel 50 used in the first embodiment. Although not shown, a film switch must be used corresponding to the luminescent panel 50′ in the second embodiment in place of the film switch 40 used in the first embodiment. The luminescent panel 50′ is printed with a pattern of star. Three words are printed on the luminescent panel 50′; however, only one of them is correct regarding spelling and meaning of a star. If the right word is pressed, the pattern of star is highlighted and sound is provided as shown in FIG. 10. If a wrong word is pressed, the pattern of star remains dim and the speaker 32 remains silent as shown in FIG. 11.

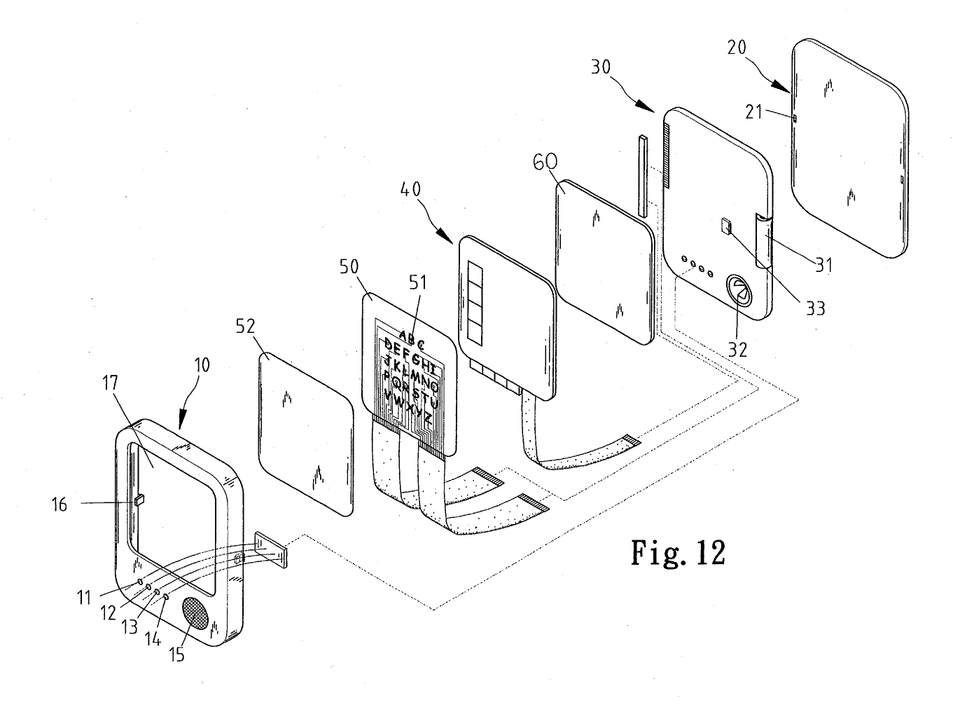

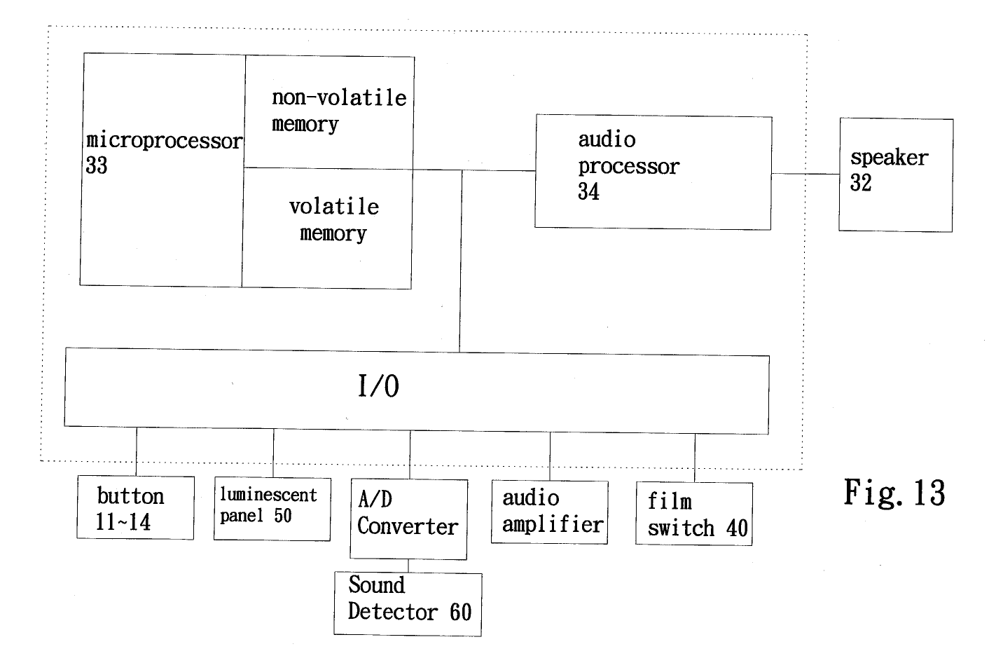

Referring to FIGS. 12 and 13, the luminescent book shown in FIG. 1 is equipped with a sound detector 60 connected with an I/O thereof through an A/D converter.

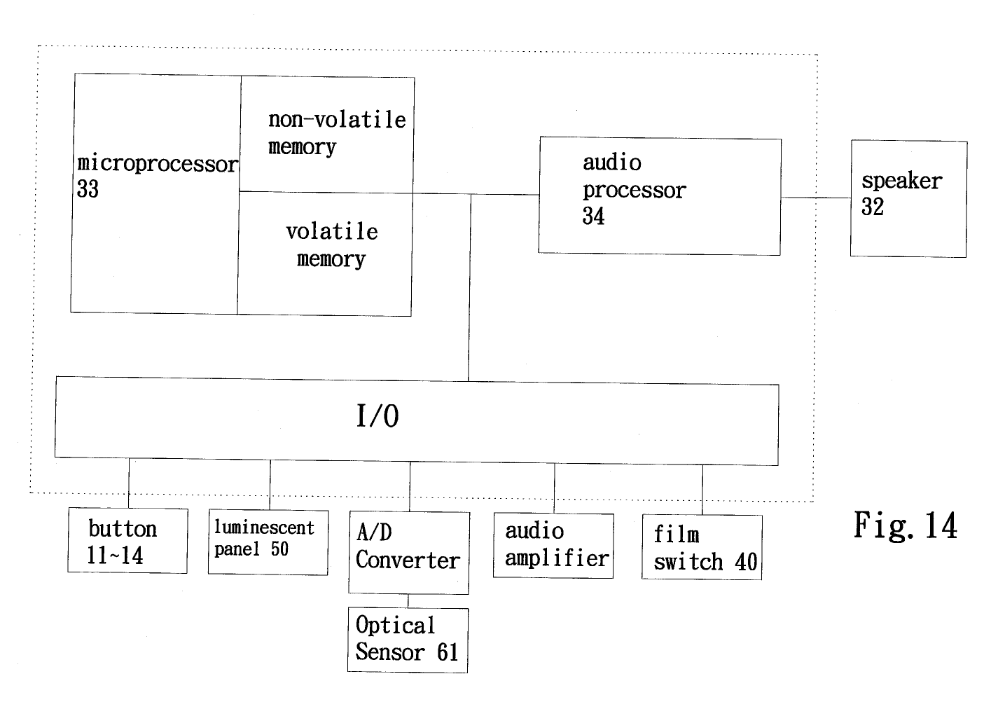

The sound detector 60 shown in FIGS. 12 and 13 may be replaced with an optical detector 61 shown in FIG. 14.

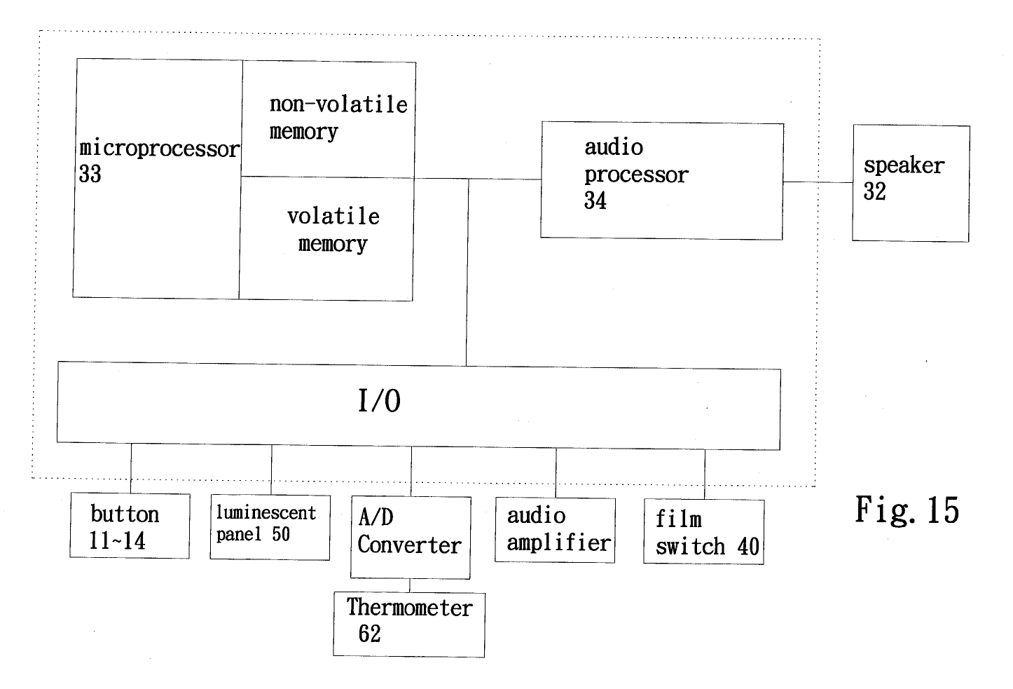

The sound detector 60 shown in FIGS. 12 and 13 may be replaced with a thermometer 62 shown in FIG. 15.

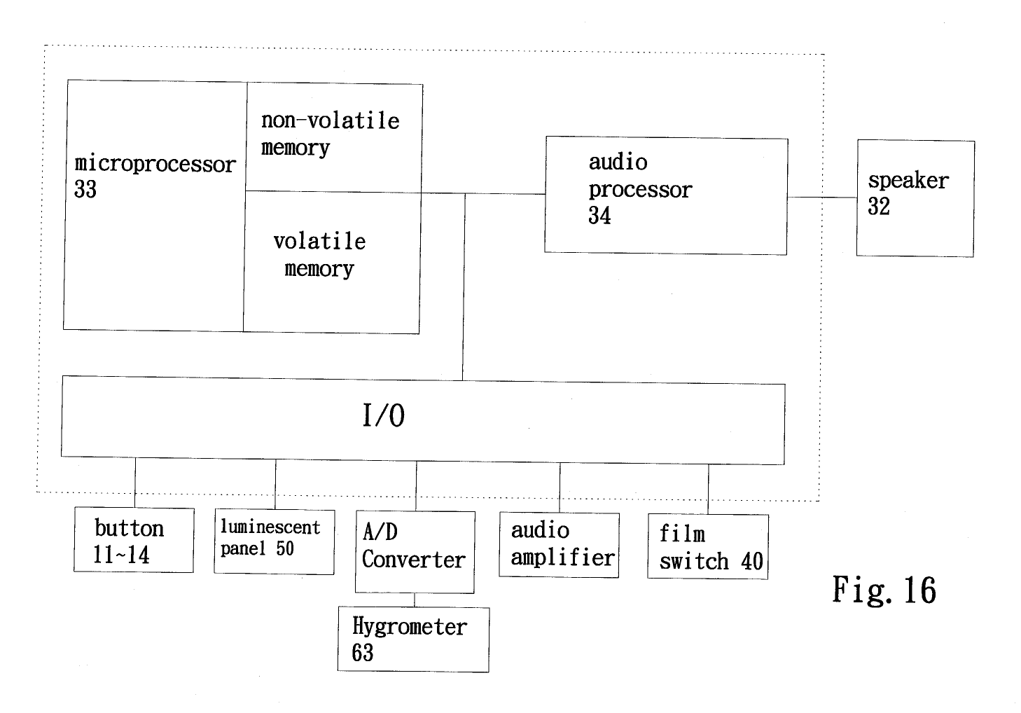

The sound detector 60 shown in FIGS. 12 and 13 may be replaced with a hygrometer 63 shown in FIG. 16.

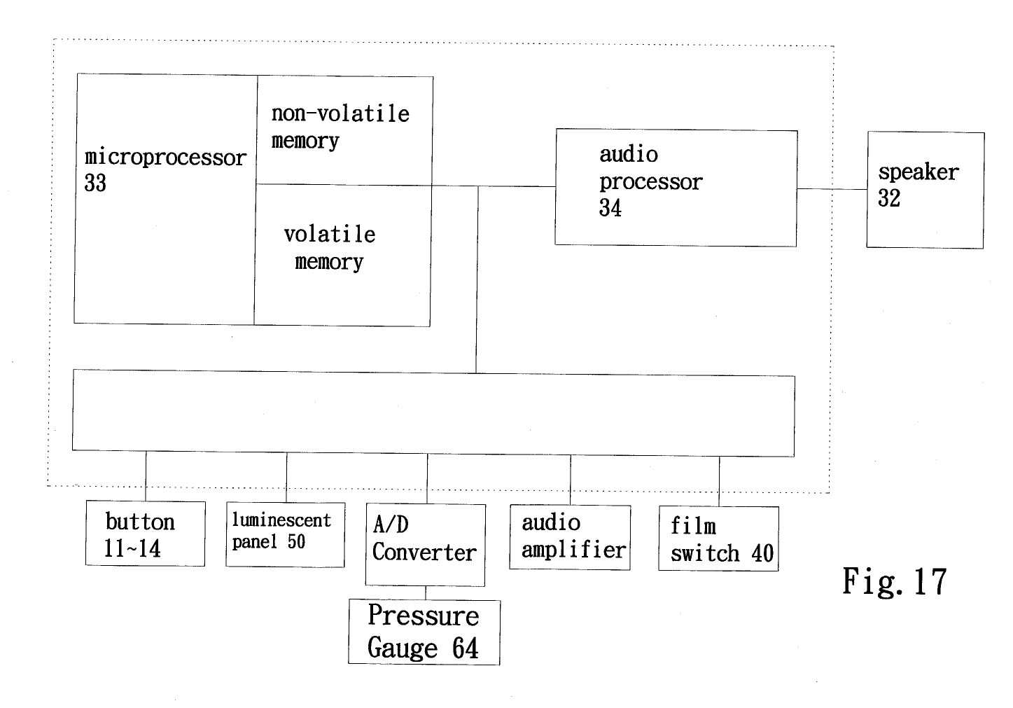

The sound detector 60 shown in FIGS. 12 and 13 may be replaced with a pressure gauge 64 shown in FIG. 17.

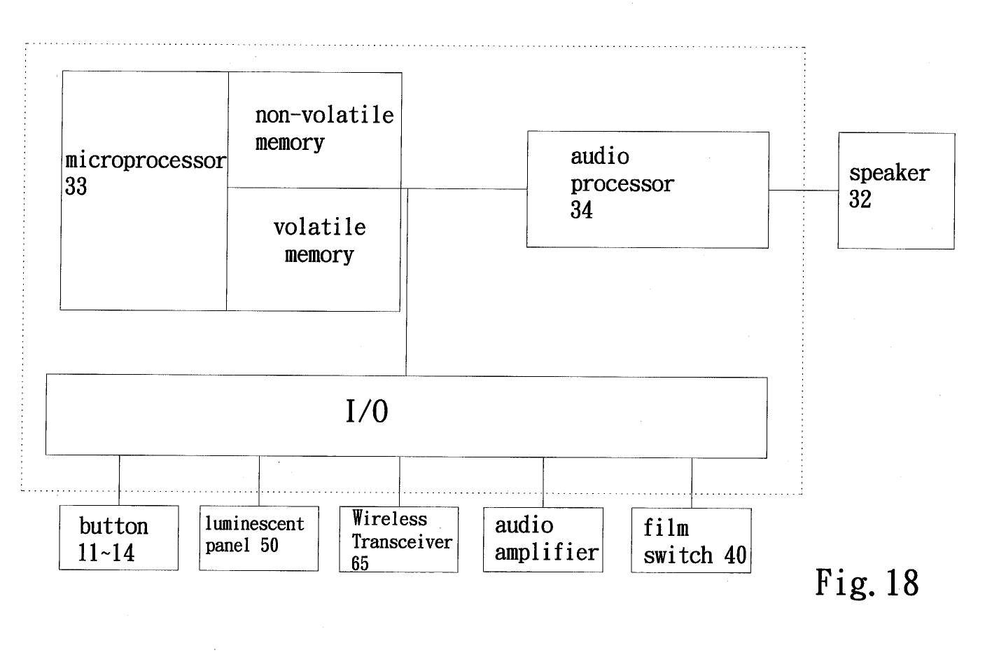

The sound detector 60 shown in FIGS. 12 and 13 may be replaced with a wireless transceiver 65 shown in FIG. 18.

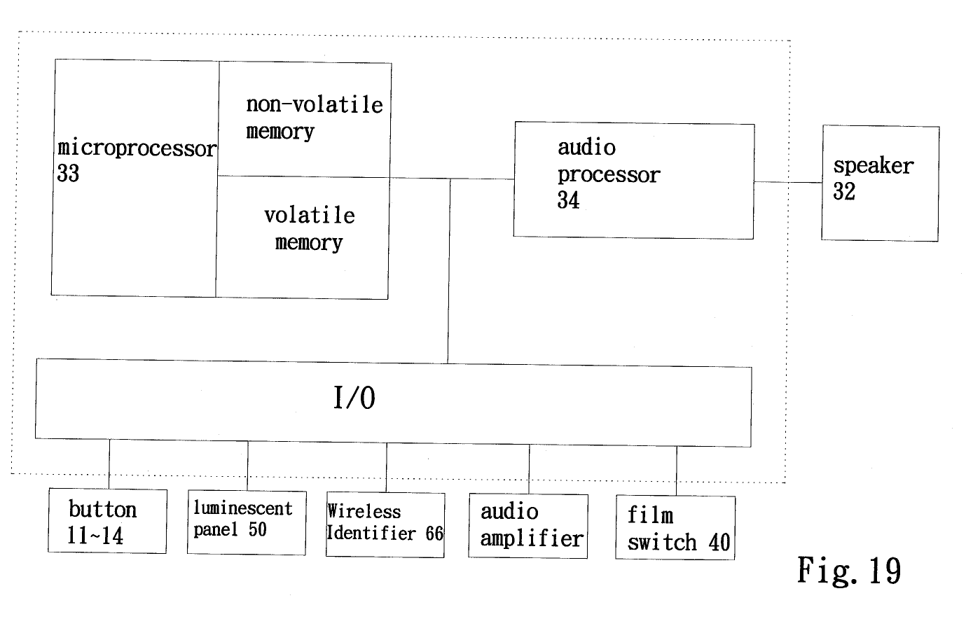

The sound detector 60 shown in FIGS. 12 and 13 may be replaced with a wireless identifier 66 shown in FIG. 19.

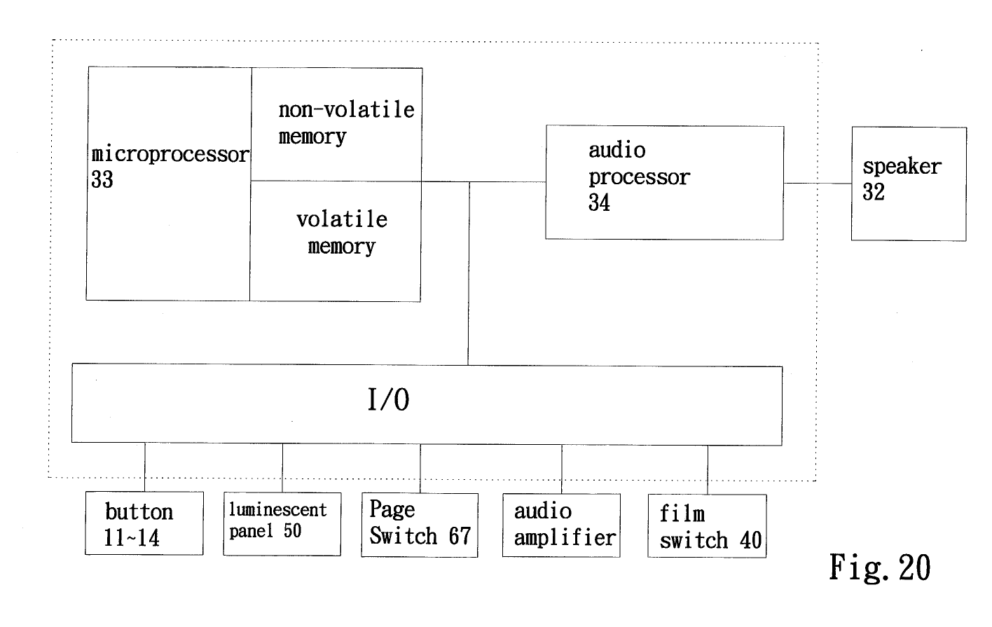

The sound detector 60 shown in FIGS. 12 and 13 may be replaced with a page switch 67 shown in FIG. 20.

The preferred embodiment of the present invention has been described in detail for illustrative purposes. Those skilled in the art can derive a lot of variations from these embodiments after a study of this patent specification. Therefore, these embodiments shall by no means limit the scope of the present invention. The scope of the present invention can only be defined in the attached claims.

1. A luminescent book including a frame (10), a luminescent panel (50) mounted on the frame (10), a film switch (40) mounted on the frame (10) next to the luminescent panel (50), a circuit board (30) mounted on the frame and electrically connected with the luminescent panel (50) and the film switch (40) for providing information in a plurality of interactive modes and a back plate (20) mounted on the frame (10) for retaining the luminescent panel (50), the film switch (40) and the circuit board (30) on the frame (20).

2. A luminescent book according to claim 1 wherein the luminescent panel (50) is divided into a plurality of areas each of which is formed with a pattern and can be activated regardless of the other.

3. A luminescent book according to claim 2 including a speaker (32) electrically connected with the circuit board (30).

4. A luminescent book according to claim 3 including a net (15) covering a hole defined in the frame (10) for protecting the speaker (32).

5. A luminescent book according to claim 3 wherein the frame (10) includes a first button (11), a second button (12), a third button (13) and a fourth button (14) provided thereon and electrically connected with the circuit board (30), each of the buttons (11, 12, 13, 14) can be pressed to select a corresponding interactive mode of provision of information.

6. A luminescent book according to claim 5 wherein the first button (11) can be pressed to start a first mode in which the circuit board (30) drives the luminescent panel (50) to highlight the patterns sequentially and when a pattern is highlighted, the circuit board (30) drives the speaker (32) to provide sound representative of the highlighted pattern, and the process repeats once if the first button (11) is pressed within a period of time after the last pattern is highlighted and ends if otherwise.

7. A luminescent book according to claim 6 wherein each pattern is highlighted twice before the next pattern is highlighted.

8. A luminescent book according to claim 6 wherein the period of time is 10 seconds

9. A luminescent book according to claim 5 wherein the second button (12) can be pressed to start a second mode in which one of the patterns can be pressed so that the film switch (40) detects the motion and sends a signal representative of the pressed pattern to the circuit board (30) so that the circuit board (30) drives the luminescent panel (50) to highlight the pressed pattern before circuit board (30) drives the speaker (32) to provide sound representative of the pressed pattern, and the process repeats if any of the patterns is pressed within a period of time after the sound is provided and ends if otherwise.

10. A luminescent book according to claim 9 wherein twice before the audio IC 34 drives the speaker 32 to provide sound representative of the pressed pattern.

11. A luminescent book according to claim 9 wherein the period of time is 10 seconds.

12. A luminescent book according to claim 5 wherein the third button (13) can be pressed to start a third mode in which the circuit board (30) drives the luminescent panel (50) to randomly highlight one of the patterns, and the process ends if the highlighted pattern is not pressed within a period of time after the highlighting starts and the circuit board (30) drives the speaker (32) to make sound representative of the highlighted pattern if otherwise.

13. A luminescent book according to claim 12 wherein the highlighted pattern is highlighted twice.

14. A luminescent book according to claim 12 wherein the period of time is 30 seconds.

15. A luminescent book according to claim 5 wherein the fourth button (14) can be pressed to start a fourth mode in which the circuit board (30) drives the speaker (32) to play a song representative of the patterns, and the process repeats if the fourth button (14) is pressed within a period of time after the song is over and ends if otherwise.

16. A luminescent book according to claim 15 wherein the period of time is 10 seconds.

17. A luminescent book according to claim 1 including a screen (52) located between the frame (10) and the luminescent panel (50).

18. A luminescent book according to claim wherein the screen (52) may be printed with any preferred color.

19. A luminescent book according to claim 17 wherein the screen (52) is transparent to allow the information provided by the luminescent panel (52) to be visible through the screen 52,

20. A luminescent book according to claim 17 wherein the screen (52) is flexible.

21. A luminescent book according to claim 1 wherein the frame (10) includes two hooks (16) projecting from a rear side thereof and the back plate (20) defines two holes (21) for receiving the hooks (16), thus securing the back plate (20) to the frame (10).

22. A luminescent book according to claim 5 wherein the luminescent panel (50′) is formed with a pattern and a plurality of words among which only one is correct in representing the pattern, and the pattern is highlighted and sound is provided if the right word is pressed and the pattern remains dim and the speaker (32) remains silent if otherwise.

23. A luminescent book according to claim 1 including a sound detector (60) connected with the circuit board (30).

24. A luminescent book according to claim 1 including an optical detector connected with the circuit board (30).

25. A luminescent book according to claim 1 including a thermometer connected with the circuit board (30).

26. A luminescent book according to claim 1 including a hygrometer connected with the circuit board (30).

27. A luminescent book according to claim 1 including a pressure gauge connected with the circuit board (30).

28. A luminescent book according to claim 1 including a wireless transceiver connected with the circuit board (30).

29. A luminescent book according to claim 1 including a wireless identifier connected with the circuit board (30).

30. A luminescent book according to claim 1 including a page switch connected with the circuit board (30).
